(19) United States
(12) Patent Application Publication
(10) Pub. No.: US 2018/0052589 A1
(43) Pub. Date: Feb. 22, 2018

(54) USER INTERFACE WITH TAG IN FOCUS

(71) Applicant: Hewlett Packard Enterprise Development LP, Houston, TX (US)

(72) Inventors: George Forman, Port Orchard, WA (US); Olga Shain, Haifa (IS); Hila Nachlieli, Haifa (IS)

(21) Appl. No.: 15/238,073

(22) Filed: Aug. 16, 2016

(51) Int. Cl. G06F 3/0484; G06F 3/0481; G06F 3/0482

(52) U.S. Cl. CPC G06F 3/04842; G06F 3/0482; G06F 3/04812

(57) ABSTRACT

A tag is set as a tag in focus in response to detecting a user selection of the tag. An item in an item view of a user interface is associated with the tag in focus in response to the user selecting the item.

### BACKGROUND

A computer system may allow a user to associate items with tags. A tag comprises information which may be used to classify the items. The associations between the items and the tags may be stored in memory of the computer system.

### BRIEF DESCRIPTION OF THE DRAWINGS

Examples of the present disclosure will now be described, by way of non-limiting examples, with reference to the accompanying drawings, in which:

FIG. 1A shows an example of a user interface according to the present disclosure;

FIG. 1B shows another example of a user interface according to the present disclosure;

FIG. 2 shows an example of a user selecting a tag in the user interface of FIG. 1B;

FIG. 3 shows an example of a user selecting an item in the user interface of FIG. 1B;

FIG. 4 shows an example of the user interface of FIG. 1B after a user has associated an item with a tag;

FIG. 5 is a flow chart showing an example method according to the present disclosure;

FIG. 6 is a flow chart showing an example method according to the present disclosure;

FIG. 7 is a flow chart showing an example method according to the present disclosure;

FIG. 8 is a flow chart showing an example method according to the present disclosure;

FIG. 9 is a flow chart showing an example method according to the present disclosure;

FIG. 10 shows an example of a portion of an item view of a user interface including an example special user interface element associated with an item;

FIG. 11 shows an example dialog box in an item view of a user interface;

FIG. 12 shows an example of a user positioning a cursor over a special user interface element;

FIG. 13 is a flow chart showing an example method according to the present disclosure;

FIG. 14 is a flow chart showing an example method according to the present disclosure;

FIG. 15 shows an example user interface including a tag status filter according to the present disclosure;

FIG. 16 is a flow chart showing an example method according to the present disclosure; and

FIG. 17 shows an example system according to the present disclosure.

### DETAILED DESCRIPTION

The present disclosure relates to association of items with tags. For example, the items may be entries on a list of items stored in a computing system, records or objects in a database, objects in a graphical image etc. A tag comprises information that may be used to classify the items. Tagging an item means creating an association between an item and a tag. The association may be stored in memory and/or displayed on a display of a computing system.

In some known systems a user first selects an item or plurality of items by clicking the items with a mouse and then performs an operation to tag the selected items. However, this approach is inconvenient when tagging large numbers of items. For example, the user may lose the selection of the items while selecting the appropriate tag and so be unable to complete the tagging operation.

In one example, according to the present disclosure, a tag selected by a user is set as a tag in focus. Once a tag is set as the tag in focus, the user may associate the tag with items by selecting items displayed in an item view of the user interface. A cursor having an appearance indicating the tag in focus may be displayed at least when the user engages with a part of the item view relevant to tagging. In this way the user is reminded which tag is in focus and will be associated with items which are selected. Further, a user may associate multiple items with the tag in focus, for example by clicking on multiple items in succession, or by selecting an area of the display encompassing multiple items etc.

In one example, the user interface allows the user to perform operations other than tagging, without the user first de-activating the tagging functionality or de-selecting the tag in focus. In this way the user may be able to call up menus, change application settings, enter data or perform other actions without losing the tag in focus and may go back to tagging items without re-selecting the tag in focus.

In another example, an item of interest is associated with the tag in focus, responsive to the user selecting the item of interest in a first manner and the item of interest may be associated with a tag other than the tag in focus or with an additional tag, responsive to the user selecting the item of interest in a second manner. In this way the user can associate an item with a tag other than the tag in focus and/or associate an item with multiple tags.

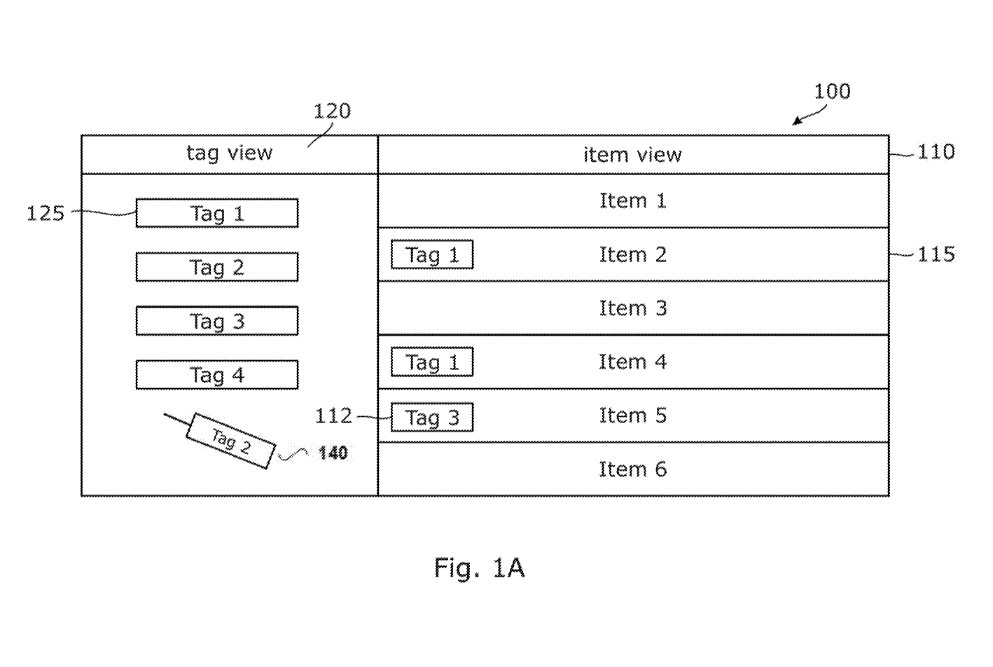

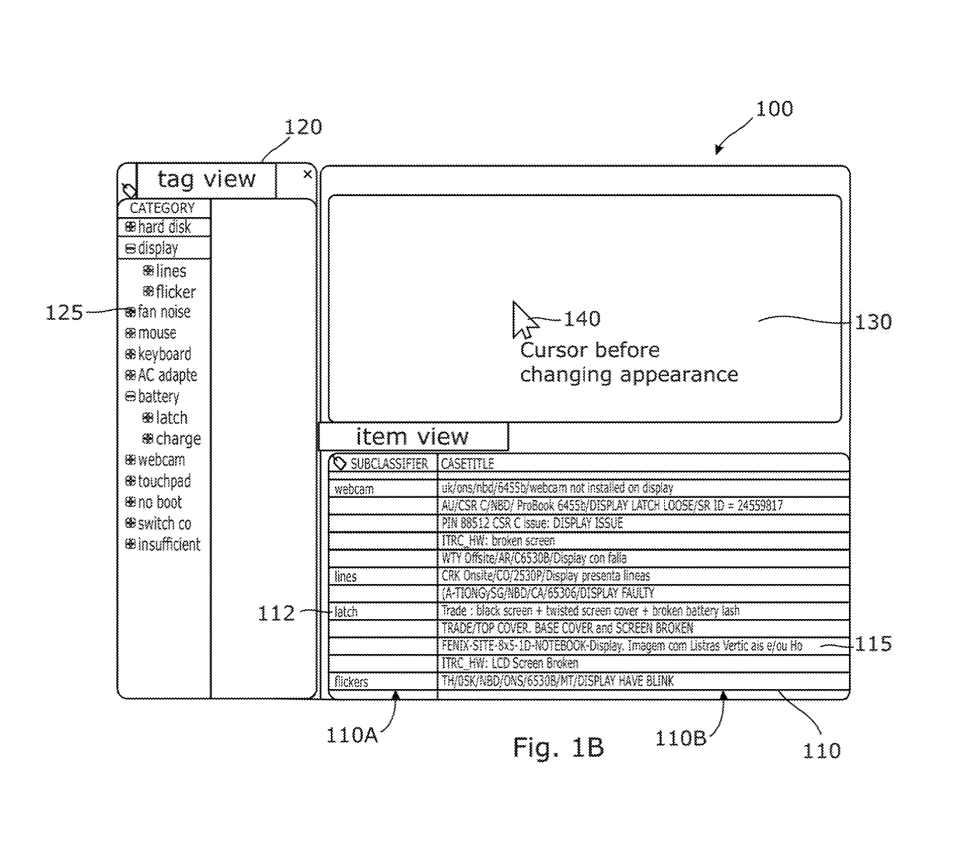

FIG. 1A shows an example user interface 100 which may be displayed on a display of a computer system. The display may for example be a computer monitor, a laptop screen, a tablet screen, an image from a projector, augmented reality display, virtual reality display etc. The computer system may for example be a desktop or laptop computer, tablet, mobile device, server or any device with a processor capable of executing machine readable instructions and displaying a graphical user interface.

The user interface 100 includes at least an item view 110 including a plurality of items 115 and a tag view 120 including a plurality of tags 125. The items 110 may for example be items on a list, records in a database, objects extracted from an image etc. by way of non-limiting example, the items may for instance be news headlines, weather reports, records of devices returned to a customer repair center, people who may be tagged in a photograph or image in social media, student records etc.

The items are to be classified by a user, as will be described in more detail below. The items may be classified by association with one or more tags. In this context, a tag is a classifier or category with which an item may be associated. A plurality of possible tags 125 are displayed in the tag view 120 and may be selected by the user. The item view 115 may indicate the association of items with tags, for example by displaying an indicator 112 of the associated tag(s) next to each item. FIG. 1A further shows a cursor 140 having a special appearance indicative of one of the tags, which will be explained in more detail later.

FIG. 1B shows a user interface 100 similar to the user interface of FIG. 1A and like reference numerals denote like parts. In FIG. 1B the item view 110 includes a plurality of rows, with each row corresponding to an item, and columns with each column providing information relating to the items. In FIG. 1B there are two columns, a column 110A which includes the item name and a column 110B which includes indicators 112 of any tags associated with each item.

In the tag view 120 of FIG. 1B, some of the tags are arranged in groups, so for instance “lines” and “flickers” are sub-categories of “display”, in this case the system may treat an association with the “lines” or “flickers” tag as indicating an association with the “display” tag as well. However, otherwise sub-categories are treated the same as any other tag as far as this disclosure is concerned. In other examples, the tags may be independent and not arranged into groups with sub-categories.

In some examples, the user interface may include further views. In FIG. 1B, in addition to the item view 110 and tag view 120, the user interface in FIG. 1B also includes an additional view 130 which provides other information and/or functionality. The exact type of information and/or functionality provided by the additional view 130 is not limited by the present disclosure and may be any of a number of types of information or functions. Thus in FIG. 1B, the additional view is left blank, but it is to be understood it could display any manner of additional information and/or user interface elements. In one example, the additional view 130 displays a visual summary, such as histograms, which summarizes the contents of a database including records that are to be categorized.

In FIG. 1B, a specific example is shown, in which the items relate to records of returned equipment at a customer care center and the tags relate to the defect or reason for repair. However, this is merely by way of example and it is to be understood that the teachings herein could be applied to any type of items and classification system using tags. While FIG. 1B has two columns, one for tags and one for item name, in other examples there could be further columns providing additional information such as city in which the customer care center is located, customer name, cost or repair etc. The rest of this disclosure will make reference to a user interface as shown in FIG. 1B, but it is understood that variations are possible while keeping within the scope of the present disclosure. For example, there may be different tags or items and there may be no additional view 130 or there may be several additional views.

The user interface in FIG. 1B also shows a cursor 140 which may be moved around the display and used to interact with items, tags and other user elements of the user interface. For example, the cursor 140 may be moved by a mouse, trackball, touch screen, camera or by optical detection of user gestures, hand movements or eye movements etc. In other examples, such as where there is a touch screen, there may be no cursor 140 or the cursor may be displayed only in certain parts of the user interface, or in response to certain user actions. The cursor 140 in FIG. 1B has an ordinary appearance which it may have before changing to a special appearance which is indicative of one of the tags, which will be explained in more detail below.

The computer system may detect a user selection of a tag and set the selected tag as the “tag in focus”. Subsequently, in response to detecting the user selecting one or more items in the item view, the computer system may associate the selected items with the “tag in focus”. The “tag in focus” is thus set in a memory of the computer system as a tag to associate with subsequently selected items in the item view. In this way a user may first select a tag and then go through a list of items and select each relevant item to associate the relevant items with the tag in focus. When dealing with numerous items to tag this approach may be more efficient than first selecting the items and then selecting a tag with which to associate the items, considering the time taken to complete the task and from the point of view of minimizing the risk of errors or losing a complex selection of a number of items.

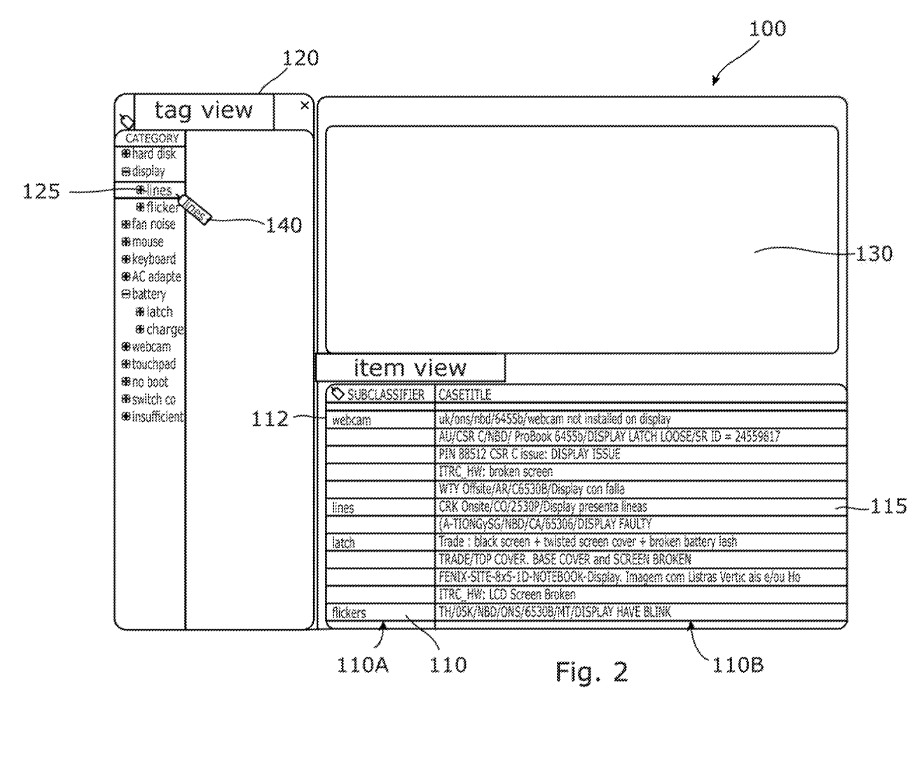

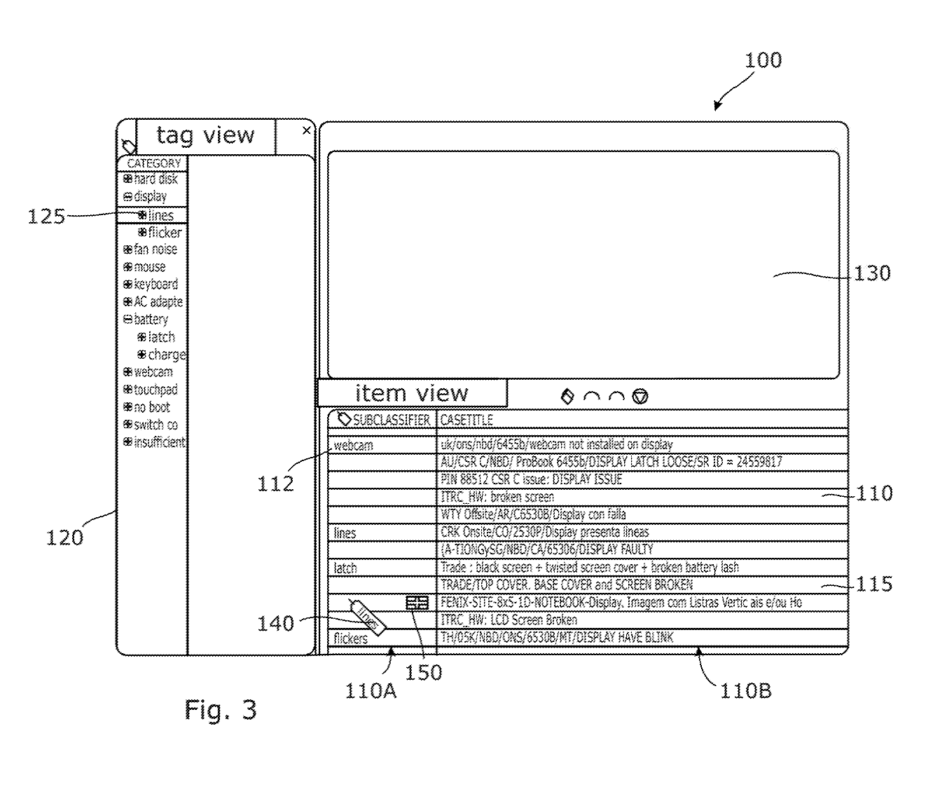

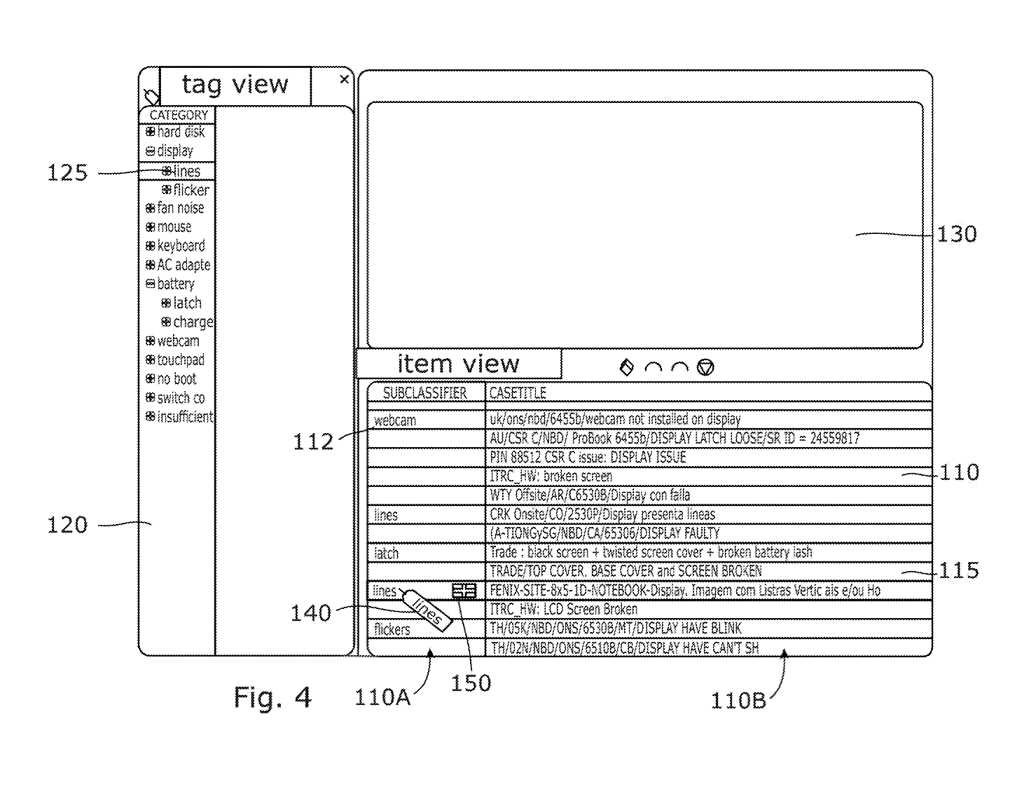

In order to help the user remember which tag is selected as the tag in focus, the user interface may display a cursor having a special appearance indicative of the tag in focus, or change the appearance of an existing cursor to a special appearance indicative of the tag in focus at least when the user engages with a part of the item view relevant to tagging. For example, the cursor with special appearance may include a graphic or text indicating the tag in focus. An example is shown in FIG. 2 where the user selects “lines” as the tag in focus and in response to this selection the appearance of the cursor 140 is modified to include the word “lines”. In FIG. 3 the user moves the cursor to the item view. In FIG. 4 the user selects the item “FENIX-SITE NOTEBOOK DISPLAY” in the item view and the selected item is associated with the tag “lines”.

The special cursor having the appearance indicative of the tag in focus, is displayed at least when the user engages with a part of the item view relevant to tagging. It may be displayed at other times as well.

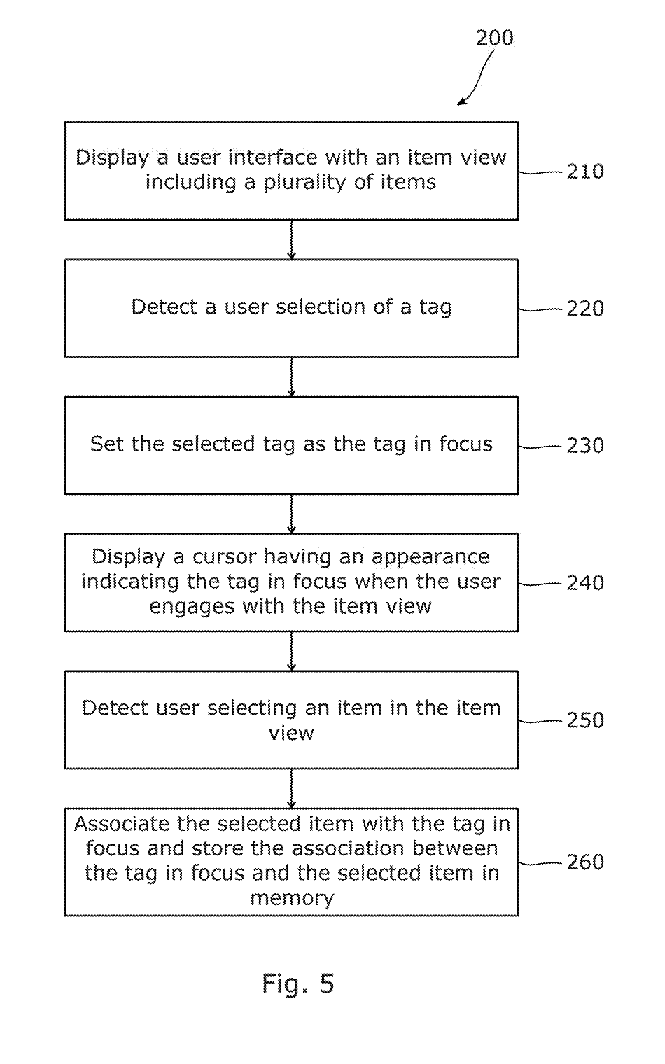

A more general example, will now be explained with reference to the flow chart of FIG. 5 which is one example of a computer implemented method 200 according to the present disclosure. The computer implemented method may be implemented by a processor executing machine readable instructions stored on a non-transitory computer readable medium, such as memory, hard disk or the like.

At block 210 a user interface including an item view comprising a plurality of items is displayed on a display of the computer system.

At block 220 the computer system detects a user selection of a tag. The user selection may for example be by clicking a tag in the tag view, by voice detection of the user requesting the tag, or another type of user input.

In the context of this disclosure the term “clicking” or “user click” etc is to be interpreted broadly as encompassing a user selecting the tag by clicking the tag or a predetermined area around the tag, with a mouse or trackball button or tapping a touch pad while a cursor is over or near the tag, tapping or touching a relevant area of at touch screen, pointing to the selected tag for at least a predetermined period of time, making a selection hand gesture with respect to the selected tag, placing a hand or finger in a volume of 3D space associated with the tag in the user interface for at least a predetermined period of time, or other similar manners of selection. In this disclosure, the term “clicking” is also to be interpreted in the same broad manner when used in the context of clicking an item, or clicking another user interface element etc., as will be discussed in examples below.

At block 230 the computer system sets the selected tag as the tag in focus. This may include storing in a memory of the computer system that the selected tag is the tag in focus.

At block 240 a cursor having an appearance indicating the tag in focus is displayed at least when the user engages with a part of the item view relevant to tagging. A part of the item view relevant to tagging is a part which a user may interact with, by clicking, pointing or gesturing etc, to associate an item with the tag in focus. In the example of FIGS. 2-4 for instance, this may be the column 110B.

In this context “engages” means when the user moves a mouse cursor to the relevant part of the item view, moves a finger within a predetermined distance of the relevant part of the item view area of a touch screen, touches the relevant part of the item view, points at the relevant part of the item view for at least a predetermined period of time, places a hand or finger in 3D space in a location associated with a relevant part of the item view, or otherwise interacts with the relevant part of the item view. A cursor having an appearance indicating the tag in focus is shown at least when the user engages with the relevant part of the item view. An example of a cursor having an appearance indicating the tag in focus in shown in FIGS. 3 and 4.

In some examples, the cursor with the special appearance indicating the tag in focus may also be displayed when the user engages with any part of the item view. In some examples, cursor with the special appearance is also shown when the user engages with the tag view, as shown in FIG. 2. In one example, the cursor having the special appearance indicating the tag in focus is displayed in views in which the user may select a tag or perform a tagging operation, but not in other views such as the additional view 130. In one example, a cursor having a normal appearance, such as that shown in FIG. 1B, is displayed when the user engages with views other than the tag view and the item view. In still other examples, the cursor having the special appearance indicating the tag in focus may be shown in all views of the user interface. In some examples, such as but not limited to implementations using a touch screen, the cursor may not be visible in normal operation, but may appear in response to the user engaging with the part of the item view relevant to tagging, any part of the item view and/or the tag view, or in response to the performing a specific action such as tapping the touch screen or placing a finger within a predetermined distance of the touch screen. All of these variations are considered to be within the scope of “at least when the user engages with a part of the item view relevant to tagging”, because in all of these variations the special cursor is shown at least when the user engages with the part of the item view relevant to tagging and in some variations it is shown at other times as well.

At block 250 the computer system detects the user selecting an item in the item view. For example, the user may select an item by clicking the item in the item view. In this respect, the term “clicking” is to be given the broad interpretation discussed above.

For example, it is not limited to clicking a mouse button, but may include tapping a touch pad, pointing at the item for a predetermined period of time or make a gesture to select the item etc. Further, “clicking the item” is to be interpreted broadly to include clicking or performing another similar action on a predetermined area around or near the item so as to select the item. For instance, in the example of FIGS. 2-4 clicking the item may refer to clicking or performing a similar action on the tag column 110A in the row relating to the item.

At block 260 the computer system associates the selected item with the tag in focus and stores the association between the selected item and the tag in focus in memory.

The association is between a particular item and a particular tag. For instance, if an item of interest is selected while “lines” is the tag in focus and the association is stored in memory, then if the tag in focus is subsequently changed to another tag, the association between the item of interest and the “lines” tag is not changed and the memory continues to store the association between the item of interest remains and the “lines” tag.

The user may associate a plurality of items with the tag in focus by successively selecting items in the item view. For example, the user may first select a tag in focus and then associate a plurality of items with the tag in focus by clicking on each item in turn in the item view. In another example, rather than a succession of clicks on each item which is to be associated with the tag in focus, if a plurality of adjacent items are to be associated with the tag in focus, the user may select the plurality of items by selecting an area of the item view containing the items to be tagged, for instance by clicking and dragging the cursor.

The user interface may display the association between each item and the tag or tags it is associated with in the item view. As shown in FIGS. 1-4 the item view may include a plurality of rows and columns, with each row corresponding to an item, one of the columns indicating the item name or an item identifier and another column indicating the tag or tags with which the item is associated with.

After associating one or more items of interest with the tag in focus, the user may select another tag in focus. For example, by returning to the tag view and selecting another tag as the tag in focus. The appearance of the cursor may be updated to indicate the new tag in focus. The user may then return to the item view and proceed to associate items with the new tag in focus. In one example, the tag in focus may act as a toggle so that a user selection of an item not associated with the tag in focus results in associating the selected item with the tag in focus, while a user selection of an item already associated with the tag in focus results in the association between the item and the tag in focus being removed so that the item is no longer associated with the tag in focus.

By displaying a cursor having a special appearance indicating the tag in focus, at least when the user engages with a part of the item view relevant to tagging, the user interface indicates to the user which tag is in focus. In this way the user knows which tag will be associated with an item selected by the user in the item view.

As mentioned above, in some implementations the user interface may display a cursor 140 in all views the user interface. This is typical of, but not limited to, cases where the user interacts with the user interface by using a mouse, trackball or touch pad etc. In this case, as the cursor already exists, the computer system modifies the appearance of the cursor in response to the user selecting a tag as the tag in focus.

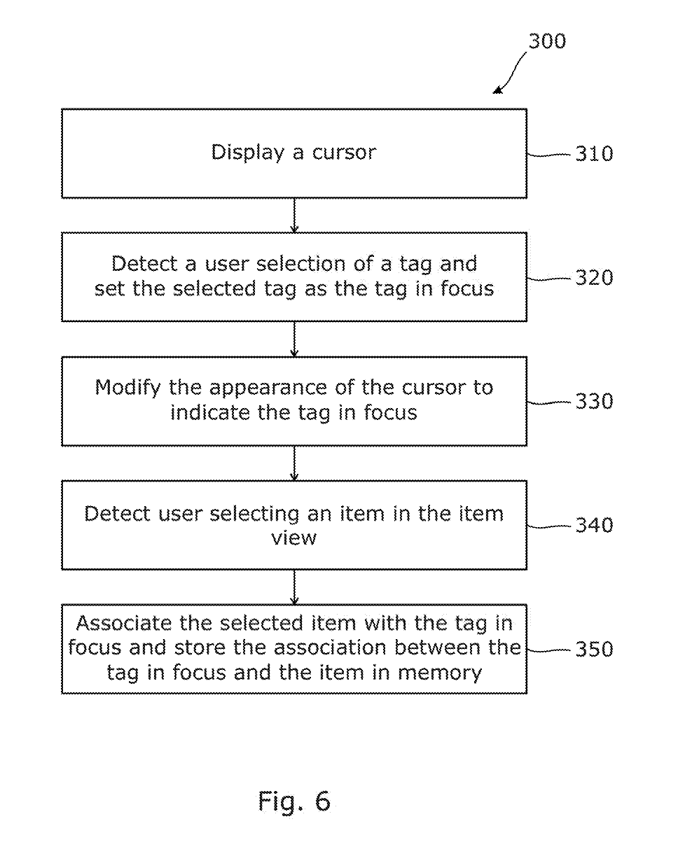

FIG. 6 shows an example method 300 in which the appearance of the cursor is modified. The method may be carried out by a processor executing instructions stored on a non-transitory computer readable storage medium.

At block 310 a cursor is displayed in a user interface of a computer system. The cursor has an appearance which is not indicative of a particular tag. For example, it may be an arrow or other conventional cursor icon. On possible shape of cursor is shown in FIG. 2, but the present disclosure is not limited to this and other shapes or appearance of cursor may be used.

At block 320 the computer system detects a user selection of a tag. The user selection of the tag may, for example, be by any of the ways described above in relation to FIG. 5. The selected tag is set as the tag in focus.

At block 330 the appearance of the cursor is modified to indicate the tag in focus. For example, the appearance of the cursor may be modified so that the cursor includes text or a graphic indicating the tag in focus.

At block 340 the computer system detects the user selecting an item in the item view.

At block 350 the computer system associates the selected item with the tag in focus and stores the association in memory.

Thus, in the method of FIG. 6, the cursor is generally visible in the user interface as the user's primary mode of interaction with the user interface and the appearance of the cursor is changed in response to the user selecting a tag as the tag in focus. The cursor may adopt the modified appearance at least in the part of the item view relevant to tagging and may change back to the normal appearance in other views and/or other parts of the item view. In one example the cursor may adopt the modified appearance in other parts of the item view, or in both the item view and the tag view. In another example, the cursor may adopt the modified appearance in other views as well and/or in all views of the user interface.

It is possible to apply the method of FIG. 6 to an implementation with a touch screen. However, in many cases a touch screen user interface may not continuously display a cursor. Thus, in one example, a cursor is displayed in response to a user engaging with the touch screen. For example, the cursor may be displayed in response to a user finger or stylus being in a predetermined proximity to the screen, or in response to a touch having a pressure or duration above a predetermined threshold. In one example, a cursor having the special appearance indicating the tag in focus may be displayed in response to the user engaging with the part of the item view relevant to tagging. For example the cursor having the special appearance may be displayed in response to a user finger or stylus being in a predetermined proximity to that part of the item view, or in response to a touch to that part of the item view having a pressure or duration above a predetermined threshold. If there is no tag selected as the tag in focus, then no cursor may be displayed, or a cursor having a normal appearance which does not indicate a tag in focus, may be displayed.

User selection of a tag provides the user interface with a “tagging functionality” whereby subsequent user selection of items in the item view results in the selected items being associated with the tag in focus. As explained above, according to one aspect of the disclosure, the user may be reminded or informed of the tag in focus by display of a cursor having a special appearance indicating the tag in focus.

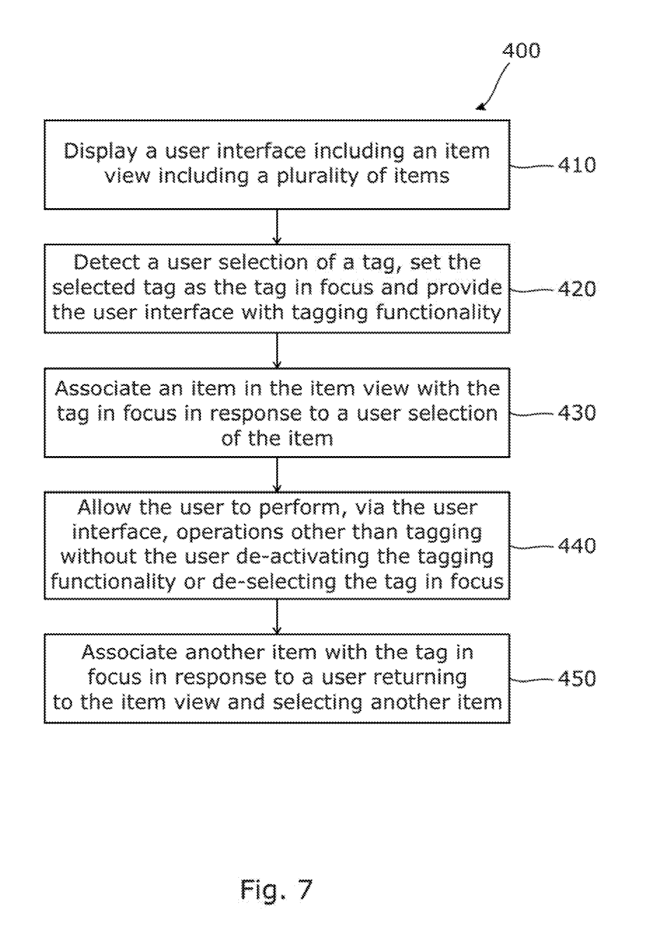

Another aspect of the present disclosure, which may be combined with the special cursor appearance, or may be implemented independently without the special cursor appearance, allows a user to perform other user interface interactions without losing the tag in focus. An example is described with reference to FIG. 7 below.

The computer implemented method 400 of FIG. 7 may be implemented by a processor executing machine readable instructions stored on a non-transitory computer readable medium, such as memory, hard disk or the like.

At block 410 a computer system displays a user interface including an item view including a plurality of items.

At block 420 the computer system detects a user selection of a tag, sets the selected tag as the tag in focus and provides the user interface with a tagging functionality.

According to the tagging functionality, a user selecting an item in the item view, while a tag is set as the tag in focus, causes the computer system to associate the selected item with the tag in focus.

At block 430, subsequent to the user selection of the tag in focus, the computer system detects a user selection of an item in the item view. This item may be referred to as “an item of interest” as it is an item selected by the user. The selection may be by any of the methods described above in relation to the earlier figures. In response to detecting the user selection of the item, the computer system associates the item with the tag in focus. The association between the item and the tag may be stored in memory and/or displayed in the user interface.

At block 440 the computer system allows the user to perform, via the user interface, operations other than tagging without the user de-activating the tagging functionality or de-selecting the tag in focus.

Examples of operations other than tagging may include, but are not limited to, the user calling an application menu to save data to disk, change application options or settings, or performing an operation within a part of the user interface view other than the tag view and the item view, or performing an operation unrelated to tagging in the item view. For instance the user may interact with a user interface element in the additional view 130, or select, enter or manipulate data within the additional view 130.

The computer system allows the user to perform the non-tagging operations at block 440 without first performing an action to de-activate the tagging functionality of the user interface or de-select the tag in focus. That is the user is able to go straight to the additional view or elsewhere in the user interface and perform the operation other than tagging without first de-selecting the tag in focus or turning off the tagging functionality.

At block 450 in response to detecting the user returning to the item view and selecting an item in the item view, the computer system associates the selected item with the tag in focus. The computer system enables the user to do this without first having to re-select the tag in focus in the tag view and without requiring the user to click a particular user interface element to re-active at the tagging functionality. Rather, the tag in focus is held in memory and the user is able to return to tagging items simply by returning to the item view. For instance, the user may return to the item view by moving a cursor to the item view, positioning a finger or stylus in close proximity to the item view, touching the item view on the touch screen, pointing at the item view or gesturing to the item view etc.

The computer implemented method of FIG. 7 thus provides the user with a convenient method of tagging in which the user is able to set a tag as the tag in focus, perform operations other than tagging and return to tagging with minimum inconvenience. The user may be able to move between tagging and non-tagging operations without needing to perform additional actions to de-activate or re-active the tagging functionality, and with needing to de-select or re-select the tag in focus.

A further aspect of the disclosure will now be described, which allows the user to associate an item with multiple tags and/or to associate an item with a tag other than the tag in focus. This aspect of the present disclosure may be combined with part, or all, of any of the above described aspects of the disclosure, or may be implemented independently of the other aspects of the disclosure.

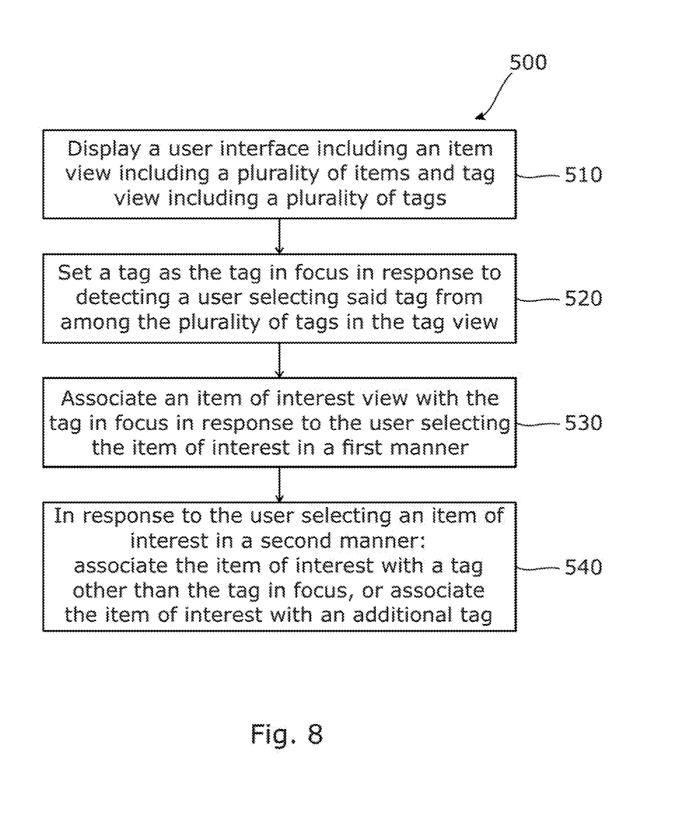

An example computer implemented method is shown in FIG. 8. The computer implemented method 500 of FIG. 8 may be implemented by a processor executing machine readable instructions stored on a non-transitory computer readable medium, such as memory, hard disk or the like.

At block 510 the computer system displays a user interface including an item view including a plurality of items and a tag view including a plurality of tags. For example, the user interface may be similar to the user interfaces shown in any of FIGS. 1-4.

At block 520 the computer system detects a user selecting a tag from among the plurality of tags in the tag view and sets the selected tag as the tag in focus. The user selection of the tag may be in any of the ways described in the above methods

At block 530 in response to detecting the user selecting the item of interest in a first manner, the computer system associates an item of interest with the tag in focus. The “item of interest” is any tag selected by the user. The selection in the first manner refers to a particular way in which the user selects the item of interest and will be explained in more detail below.

At block 540 in response to detecting the user selecting the item of interest in a second manner, the computer system associates an item of interest with a tag other than the tag in focus, or associates the item of interest with an additional tag. The “item of interest” is any tag selected by the user. The selection in the second manner refers to a particular way in which the user selects the item of interest and will be explained in more detail below. The second manner of selection is different from the first manner of selection. An additional tag is a tag in addition to a tag which the item is already associated with.

At blocks 530 and 540 the association of the item of interest with a tag may be stored in memory. The association may be displayed in the item view.

Thus, in response to a user selection in a first manner the item of interest is associated with the tag in focus. This is similar to the method described in FIG. 5. However, if the user selects the item of interest in a second manner, then the item of interest may be associated either:

(i) with a tag other than the tag in focus; or

(ii) with an additional tag (known as multiple tagging)

A computer system which is capable of doing only one of the above (i) or (ii) is considered to be in accordance with an aspect of the present disclosure and the flow chart of FIG. 8. However, some computer systems may be able to do both. Thus, a computer system which is capable of doing either (i) or (ii), depending upon the circumstances or other user input, is also considered to be in accordance with an aspect of the present disclosure and the flow chart of FIG. 8. For instance, some computer systems may determine whether to tag with the tag in focus, or allow association with an additional tag, depending on the subsequent user input and/or existing tag associations (if any) of the selected item.

The first of these: (i) association with a tag other than the tag in focus will now be discussed. In this respect, the method enables the user to associate items with the tag in focus by successive selections of items in the item view in the first manner, but also to associate an item in the item view with a tag other than the tag in focus without leaving the item view, by selecting the item in the second manner. Having associated an item with a tag other than the tag in focus the user may then continue associating further items with the tag in focus by selecting further items in the item view in the first manner. This may all be done without leaving the item view and/or without changing the tag in focus.

Selecting an item in the second manner may be quicker, require fewer user actions and/or provide a superior user experience compared to returning to the tag view, selecting a new tag in focus, and then returning to the item view to associate the item of interest with the new tag in focus. The method of FIG. 8 thus enables the user to associate one item, or a few items, with a tag other than the tag in focus, without breaking the flow of associating most items with the tag in focus.

The mechanics of determining whether a user has selected an item in the first manner or the second manner will now be discussed, with reference to some examples, before returning to the topic of associating an item of interest with a tag other than the tag in focus or with multiple tags.

The computer system may determine that the user has selected an item of interest in the first manner in response to detecting the user clicking the item of interest in the item view. Here and elsewhere in the disclosure, the term “clicking” should be interpreted broadly as encompassing a user selecting the item by clicking the item, or an area associated with the item, with a mouse or trackball button or tapping a touch pad while a cursor is over the item, tapping or touching a relevant area of at touch screen, pointing to the selected item for at least a predetermined period of time or making a selection hand gesture with respect to the selected item, or other manners of selection.

The computer system may determine that the user has selected an item of interest in the second manner if it detects a selection in manner which is distinct from the first manner, for example but not limited to: an extended user click on the item of interest lasting more than predetermined period of time, a double click on the item of interest, or a user click on a special user interface element associated with the item of interest. In other examples the first manner and second manners of selection may include any of the above, as long as they are different from each other; e.g. the first manner could include a double click and the second manner a single click or vice versa.

As will be appreciated from the above, the tag with which a selected item is associated may be varied according to the manner in which the user selects the item. If the user selects the item in a first manner then the item may be associated with the tag in focus. The first manner may be, but is not limited to, a single click. If the user selects the item in a predetermined second manner, which can be distinguished from the first manner, then the computer system may associate the selected item with a tag other than the tag in focus.

In one example, a user selecting an item in a second manner comprises a user selecting an item by clicking a special user interface element associated with the item. Thus, the computer system determines that an item in the item view is selected in the second manner when a user clicks on a special user interface element associated with the item of interest. The special user interface element may for example be an ‘add tag button’ 150 as shown in FIGS. 3 and 4. The particular appearance of the add tag button 150 shown in FIGS. 3 and 4 is just an example and the button could have a different shape, size, position or appearance. The special user interface element 150 may be displayed next to the item in the item view and in the illustrated example is in the same row as the item name. Thus clicking the item name may be interpreted as selecting the item in the first manner, while clicking the special user interface element 150 may be considered to be selecting the item in the second manner. Depending on the implementation, the special user interface element may be displayed at all times, or just when the use engages with the part of the item view relevant to tagging, or just for one item at a time when the user engages with a particular item by moving the cursor over the item, moving a finger or stylus over the item or pointing at the item etc.

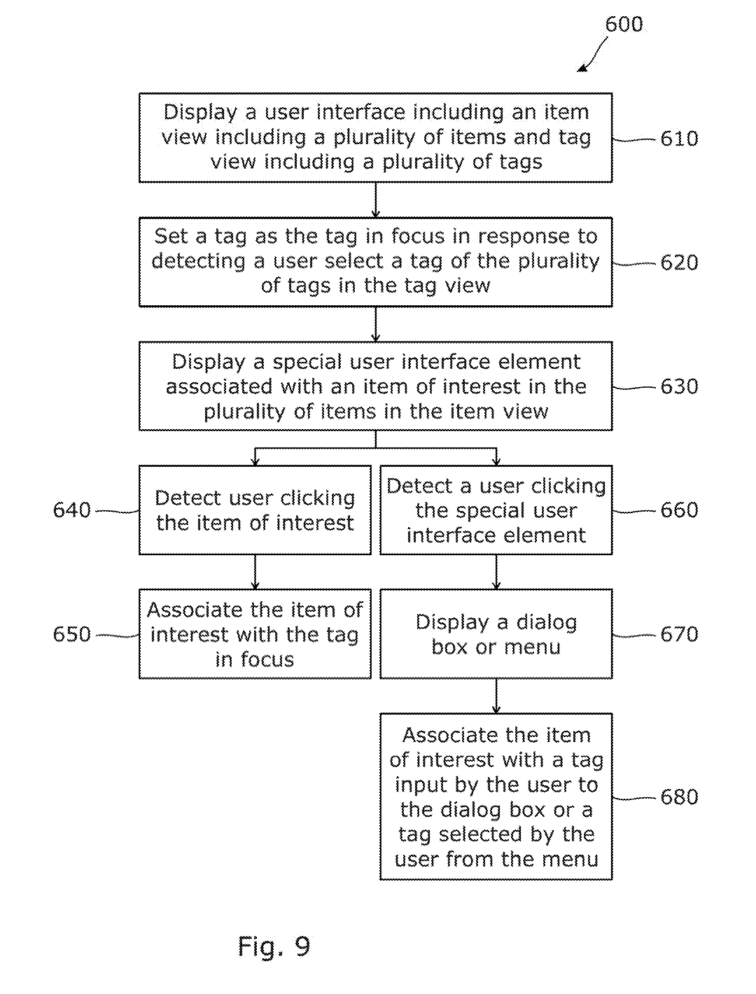

FIG. 9 shows an example computer implemented method 600 which uses the special user interface element. In this method selecting the item in the first manner comprises clicking the item and selecting the item in the second manner comprises clicking the user interface element. The method may be implemented by a processor executing machine readable instructions stored on a non-transitory computer readable medium, such as memory, hard disk or the like.

At block 610 a user interface including an item view including a plurality of items and a tag view including a plurality of tags is displayed. At block 620 the computer system sets a tag as the tag in focus in response to detecting a user selecting a tag of the plurality of tags in the tag view. These blocks are the same as blocks 510 and 520 in the method of FIG. 8.

At block 630 the computer system displays a special user interface element associated with an item of interest in the plurality of items in the item view. The item of interest may be any item in the item view.

At block 640 the computer system detects the user clicking the item of interest and in response to this associates the item of interest with the tag in focus at block 650.

At block 660 the computer system detects the user clicking the special user interface element associated with the item of interest.

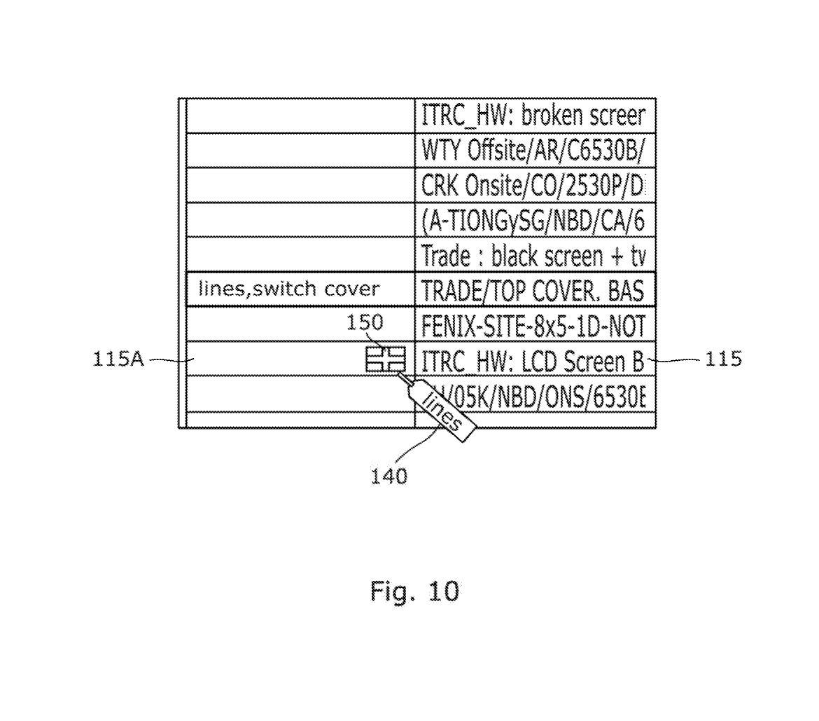

FIG. 10 shows an example of a user clicking the special user interface element 150 of an item of interest 115. In this example, the tag in focus is “lines” as shown by the special appearance of the cursor 140. In this example, the item of interest 115 is not currently associated with a tag and there is no indication of a tag association displayed in the area 115A next to the item. The computer system may interpret a click on a predefined area around the add tag button as being a click on the add tag button 150. For example, the item view may include a column for displaying items and a column for displaying tag associations. In this case the add tag button may be displayed in the same column as the tag associations and a click on that column in the same row as an item of interest may be considered as selecting the item of interest in the first manner, while a click on the add tag button in that column may be considered as selecting the item of interest in the second manner.

At block 670 in response to the detection at block 660 the computer system displays a dialog box or menu.

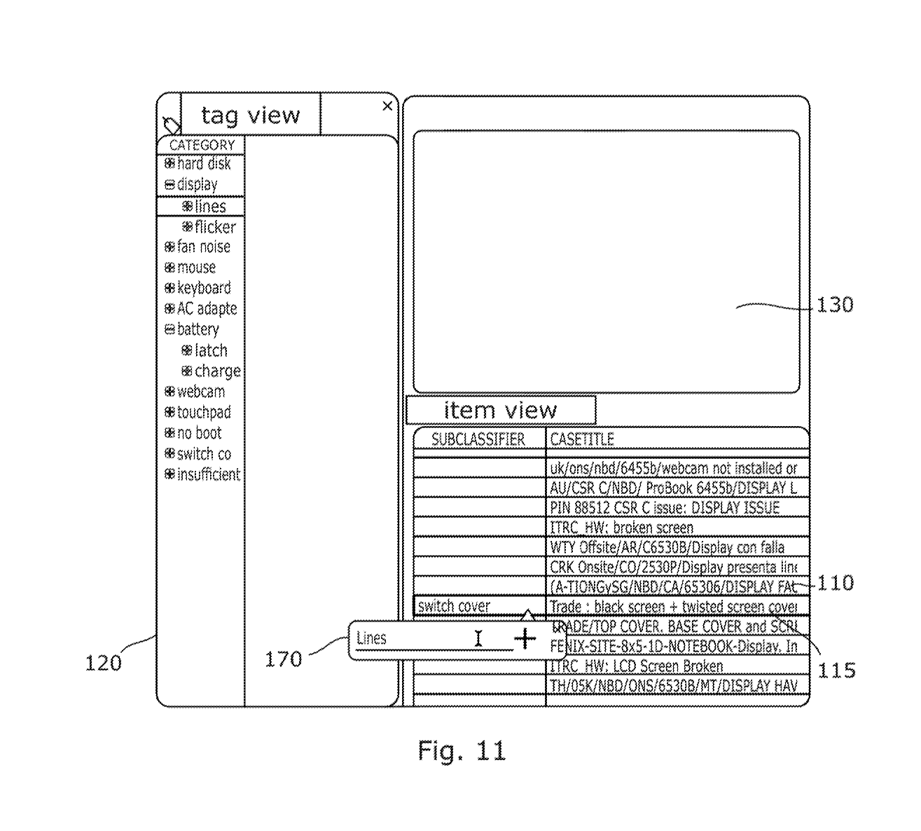

FIG. 11 shows an example of a dialog box 170 displayed in response to the user clicking the special user interface element 150. In other examples the computer system displays a menu including a plurality of tags any one of which may be selected by the user.

At block 680, the computer system associates the item of interest with a tag input by the user to the dialog box or with a tag selected by the user from the menu.

For example, the user may enter a tag by typing a tag name or otherwise inputting a tag into the dialog box. In some examples, the dialog box may be pre-populated with the tag in focus, or be pre-populated by a suggested tag generated by a classifier engine of the computer system. In that case the user may accept the pre-populated tag, or replace the pre-populated tag with their own input tag. In other examples, the dialog box may be empty and not pre-populated.

While the method of FIG. 9 describes a method in which selecting an item in the second manner comprises a user clicking special user interface element associated with the item, the same principles could be applied to other implementations in which the second manner of selection involves a double click on the item of interest, a prolonged click on the item of interest, or any other selection manner distinct from the first selection manner.

As mentioned above, by using the above described methods of FIG. 8 and/or 9, the user is able to associate the item of interest with a tag other than the tag in focus. This may be efficient from a user interface perspective. For example, assume that the tag in focus and a tag other than the tag in focus have already been defined. In order to associate an item in the item view with a tag other than the tag in focus and then go back to associating items with the tag in focus, in a system operating according to the method of FIG. 8, the user can simply use the second selection manner to associate an item with a tag other than the tag in focus, without navigating out of the item view area, then use the first selection manner to associate an item with the tag in focus, again without navigating out of the item view area. This may involve a mouse seek to select an item in the item view in the second manner, a mouse seek to select a tag other than the tag in focus from a menu, and a mouse seek to select another item in the first manner. When considering ease of use, we concentrate here on mouse seeks, as while they are just one of several low-level motor-cognitive operations the user would perform, the ‘mouse-seeks’ are considered to be one of the most time consuming operations.

The user can thus remain in the item view throughout the process and does not need to move the cursor or their attention to other parts of the user interface. In total there are three mouse-seeks and each mouse seek is relatively short to the mouse position before the seeking starts. In the terminology of user interface design, moving a cursor from one view or part of the user interface to another view or part of the user interface is called a “mouse-seek”. The term “mouse-seek” can also be used to refer to similar actions on a touch screen, or a user interface which optically detects a user's finger movements or gestures.

In contrast to the above, if the user had to return to the tag view to change the tag, then to perform the same operation, the user would have to mouse seek to the tag view, mouse seek to select a new tag, mouse seek back to the item view to select the item to be associated with the new tag, mouse seek to the tag view and mouse seek to change back to the previous tag and mouse seek to the item view to continue tagging. There are several other low-level motor-cognitive operations the user would perform, but we focus on ‘mouse-seeks’ as they are considered to be one of the most time consuming operations.

It will be appreciated that this involves six mouse-seeks rather than three mouse seeks. Moreover, mouse seeks while using the second manner are shorter and thus may be assumed to be performed quicker. Thus the method of FIG. 8 may be quicker and easier for the user. This is due to the number of mouse-seek operations and the fact that while using the second manner the ‘mouse-seeking’ s are shorter and thus quicker. Mouse seeking may be regarded as one of several low-level motor operations performed by the user which consume time the most. Mouse-seek operations may be particularly time consuming and inconvenient for the user, as they involve the user first realizing they need to mouse-seek, then looking for the desired location to mouse-seek to and finally performing a mouse-seek to the desired location. Thus cutting down on the number of mouse-seek operations may result in a more user-friendly design and enable the user to work more quickly, especially when a large number of items are to be tagged.

Some implementations of the method of FIG. 8 may also facilitate multiple tagging, as mentioned above with reference to block 540.

FIG. 8 refers to the possibility of allowing the user to associate the item of interest with an additional tag. This means that where an item is already associated with a tag, selecting the item in the second manner allows the user to associate the item with a new tag in addition to the tag which it is already associated with. In that way the item becomes associated with multiple tags. The new tag may be the tag in focus, or may be a new tag selected by the user through a dialog box or menu called up by selecting the item in the second manner. In one example, if the item is already associated with a tag other than the tag in focus, then selecting the item in the second manner may automatically associate the item with the tag in focus, without calling up a menu or dialog box.

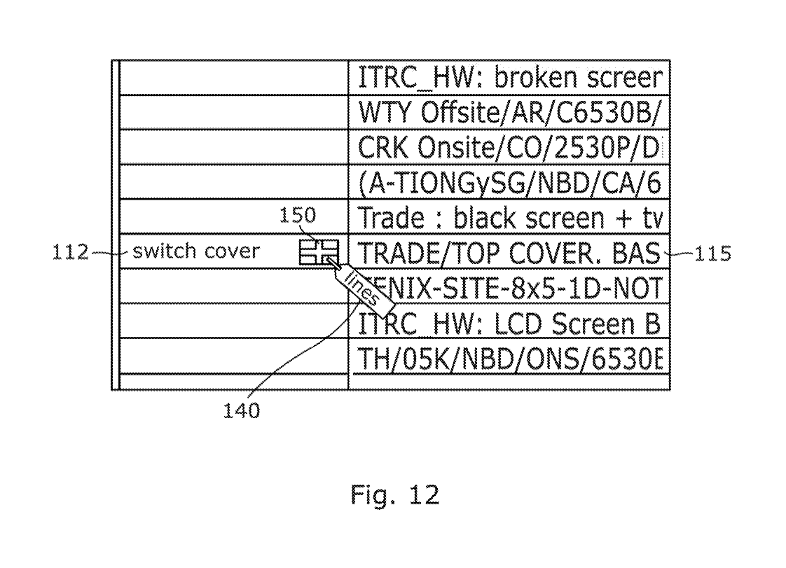

FIG. 12 shows an example in which an item 115 in the item view is already associated with the tag “switch cover”, as shown by the indication of the association 112. The tag in focus is “lines”, which is different from the tag which the item 115 is already associated with. The diagram shows the user clicking the special user interface element 150 of an item 115, i.e. selecting the item in a second manner. As a result the item 115 will be associated both with the existing tag “switch cover” and with the tag in focus “lines”. The end result can be seen in the highlighted item in FIG. 10 where the item is indicated as being associated with both “lines” and “switch cover”.

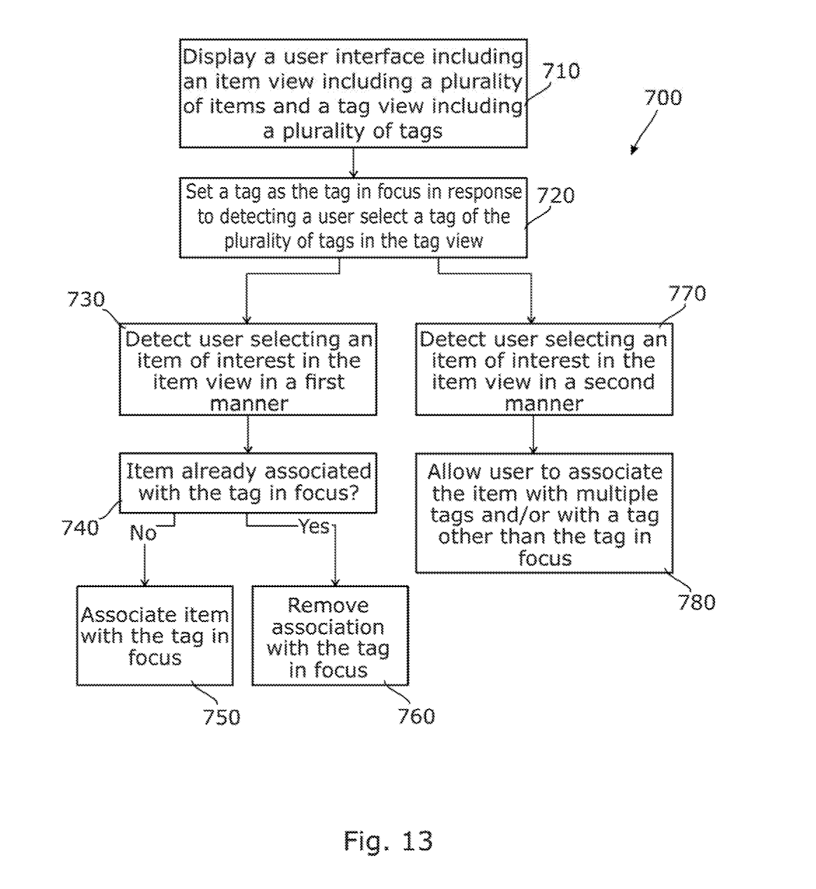

FIG. 13 illustrates an example method in more detail. The method is similar to the method of FIG. 8, but in additional describes a toggle operation in relation to selecting an item in the first manner. The method 700 of FIG. 13 may be implemented by a processor executing machine readable instructions stored on a non-transitory computer readable medium, such as memory, hard disk or the like.

Blocks 710 and 720 are the same as blocks 610 and 620 of FIG. 9.

At block 730 the computer system detects the user selecting an item of interest in the item view in a first manner.

At block 740 in response to the detection in block 730, the computer system determines whether the selected item is already associated with the tag in focus. If not, then the method proceeds to block 750 and the item is associated with the tag in focus. If the item is already associated with the tag in focus, then the method proceeds to block 760 and the association with the tag in focus is removed. Thus selecting the item in the first manner acts as a toggle to add or remove the tag in focus.

At block 770 the computer system detects the user selecting an item of interest in the item view in a second manner.

At block 780 in response to the detection in block 770, the computer system allows the user to associate the item with multiple tags and/or with a tag other than the tag in focus. This is similar to block 540 of FIG. 8A.

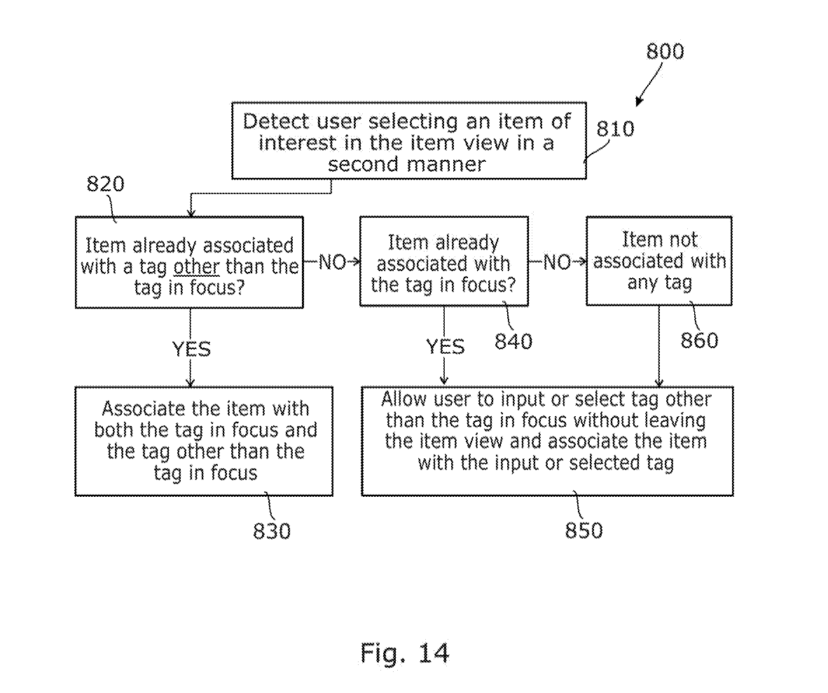

FIG. 14 illustrates one possible implementation of a method 800 in response to a user selection of an item in a second manner in more detail. The method is similar to the method of FIG. 13, but describes determining whether to associate the item with a tag other than the tag in focus or to add the tag in focus as an additional tag. The method may be implemented by a processor executing machine readable instructions stored on a non-transitory computer readable medium, such as memory, hard disk or the like.

At block 810 the computer system detects a user selecting an item of interest in the item view in a second manner.

At block 820 the computer system determines whether the selected item is already associated with a tag other than the tag in focus.

If the result of the determination at block 820 is yes, then at block 830 the item is associated with the tag in focus as an additional tag. That is the item maintains its association with the other tag which it was already associated with, but in addition is now also associated with the tag in focus. This is a quick and convenient way of adding the tag in focus as an additional tag by selecting an item in the second manner, such as but not limited to by clicking an additional tag button. In some user interface systems, selecting an item in the first manner forms an association between the item and the tag in focus and deletes any previous association. In such systems, selecting an item in the first manner cannot result in multiple tags, but selection in the second manner makes multiple tags possible.

If at block 820 it is determined that the item is not already associated with a tag other than the tag in focus, the method proceeds to block 840 and the computer system determines if the item is already associated with the tag in focus. If the determination is positive then the method proceeds to block 850 where the computer system allows the user to input or select a tag other than the tag in focus without leaving the item view and associates the item with the tag which is input or selected by the user. For example, this may be by way of the computer system displaying a dialog box or menu through which the user can input or select a tag with which the item is to be associated with. In some examples, the computer system toggles on and off an association between the item and the tag in focus in response to the item being selected in the first manner. In this case selection the second manner makes it easy for the user associate another tag with the item, in addition to the tag in focus, when the item is already associated with the tag in focus. For instance, in some cases the user may wish to associate an item with the tag in focus, but also to associate the item with another tag. This may be easily achieved by first selecting the item in the first manner to associate it with the tag in focus and subsequently selecting the tag in the second manner to associate it with another tag in addition to the tag in focus. It would also be possible to carry out these operations in reverse order, selecting the item in the second manner to associate it with a tag other than the tag in focus, before selecting the item in the first manner to associate it with the tag in focus.

If the determination at block 840 is negative this means that the item is not already associated with a tag. In that case the method proceeds to block 850 and the user is able to associate the item with a tag other than the tag in focus, for instance by inputting a tag into the dialog box or selecting a tag from a menu which has been called up in response to selecting the item in the second manner.

Of course modifications to the method are possible and within the scope of the present disclosure. For example, any selection of the item of interest in the second manner, regardless of whether or not the item is already associated with a tag, may call up a dialog box or menu through which the user may input or select a tag with which to associate the item. In that case the dialog box may be pre-populated with the tag in focus or another suggestion and the menu may pre-select or place near the top the tag in focus or another suggested tag so as to facilitate quick tagging of the item.

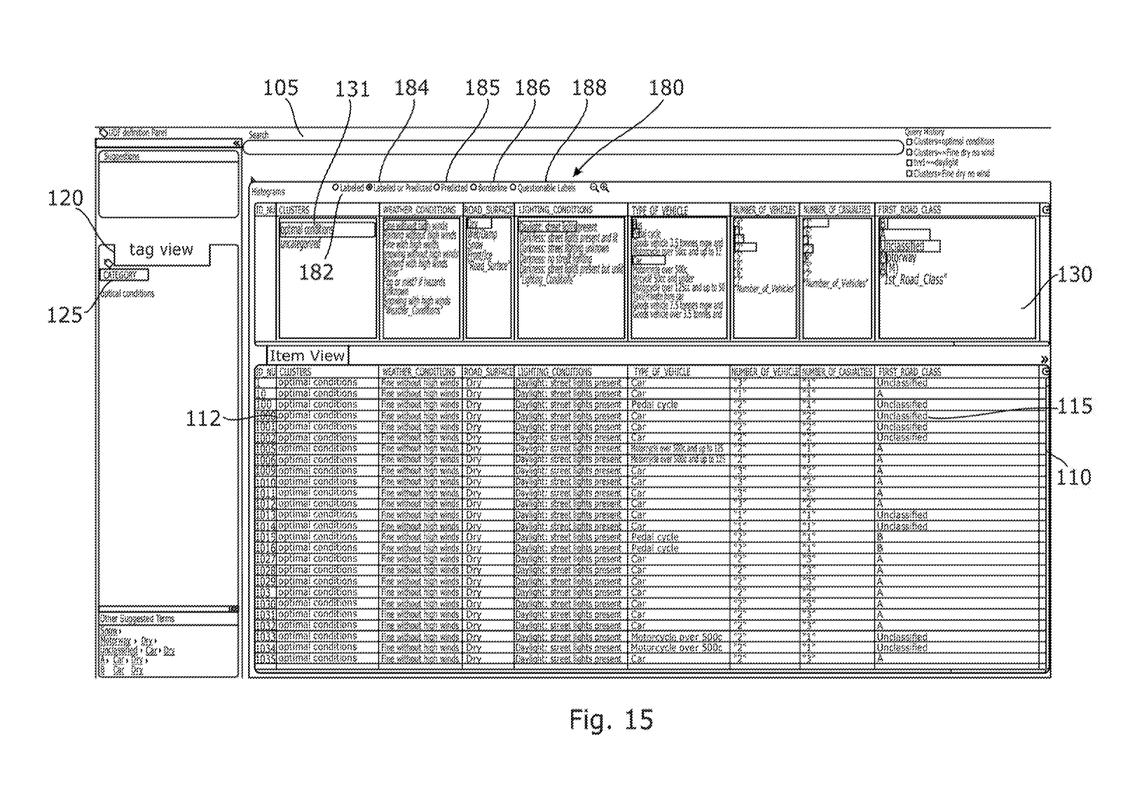

FIG. 15 shows an example user interface which is similar to the user interface shown in FIG. 1B. Like parts denote like reference numerals. In addition the user interface includes a search box 105 to search for items, for instance by item name or by a particular field of the item or by tag association of the item. The view 130 provides numerical or statistical information about the items in the item view, for instance the number of items of various types, or number of items matching certain criteria or having certain tag associations. The view 130 may be capable of producing visual representations such as histograms. The information provided in the view 130 may be responsive to criteria entered in the search box 105.

The computer system may include a prediction engine which is to classify items by automatically predicting tags for the items, or automatically predicting likelihood of items being associated with certain tags. For example, the classifier engine may return information such as a probability of each item being associated with each of a plurality of possible tags.

The view 130 includes a tag status filter selection tool 180. The tag status filter selection tool allows the user to filter the items according to their tag status. A tag status is a status which an item has in relation to tags and will be explained in more detail shortly. The filter selection tool has various tag status options 182, 184, 185, 186 and 188 and in response to the user selecting one of these options the item view 110 may highlight items matching the tag status, or show only items matching the selected tag status while not showing items which do not show the tag status. Likewise the information presented in the view 130 may be confined to items matching the selected tag status.

The tag status options include labelled 182, labelled or predicted 184, predicted 185, borderline 186 and questionable labels 188. Labelled means items which are associated with a tag by the user, e.g. by the user manually associating the tag with the item or by the user confirming a prediction made by the classifier engine. Predicted means items for which a tag is predicted by the prediction engine, but which has not been manually tagged by the user; in this context predicted may mean a single tag which is predicted by the prediction engine, the most likely tag of a plurality of possible tags predicted by the prediction engine or tags which are predicted with a likelihood above a predetermined threshold. Labelled or Predicted means items which are associated with a tag or for which a tag is predicted by a prediction engine. Borderline means items for which a likelihood of a tag according to a prediction engine is within a predetermined range, for instance this may be items for which the prediction engine is not certain of the correct tag. Questionable labels means items for which a tag associated with the item by the user contradicts the prediction engine, for example because the user input tag is different to a tag predicted by the prediction engine or because the user input tag has a low likelihood of being associated with the item according to the prediction engine. The tag status filter tool 180 may include further options, not shown in FIG. 15, such as unlabeled. The unlabeled tag status would highlight or show only items which have not been associated with a tag by the user. Another possible tag status option, not labelled or predicted, would highlight or show only items which had not been associated with a tag by the user and for which there was no strong prediction, above a predetermined probability threshold, by the prediction engine.

In some examples, the view 130 may include a class filter 131 through which the user may input a tag and in response to which the information shown in the view 130 and/or the items shown in the item view 110 are limited to items associated with, or predicted to be associated with, the input tag. In one example the tag status filter 180 may act independently of the class filter 131, e.g. if a tag status filter is selected and no tag is input into the class filter 131, then all items having a tag status matching the tag status filter are shown or highlighted regardless of which tag they are associated with. In another example, the class filter 131 and the tag status filter 180 work together, e.g. items which are associated or predicted to be associated with the tag entered in the class filter and which have a tag status matching the tag status filter are shown or highlighted. For instance, if a tag “lines” is input into the class filter 131 and the “labelled” tag status filter 182 is selected, then only items which are associated with the tag “lines” will be highlighted or shown in the item view 110.

The tag status filters may enable a user to review and tag a large number of items efficiently. For instance by selecting an unlabeled tag status filter the item view may highlight or show only items which the user has not yet associated with a tag. By selecting the borderline filter the item view may highlight or show only items for which the prediction engine is not certain of the correct tag, enabling the user to focus on the items which may be most in need of human input. By selecting the questionable labels filter the user may focus on items which may have been incorrectly labelled by the user, for instance this may be a good way to go back over the set of tagged items to check for errors.

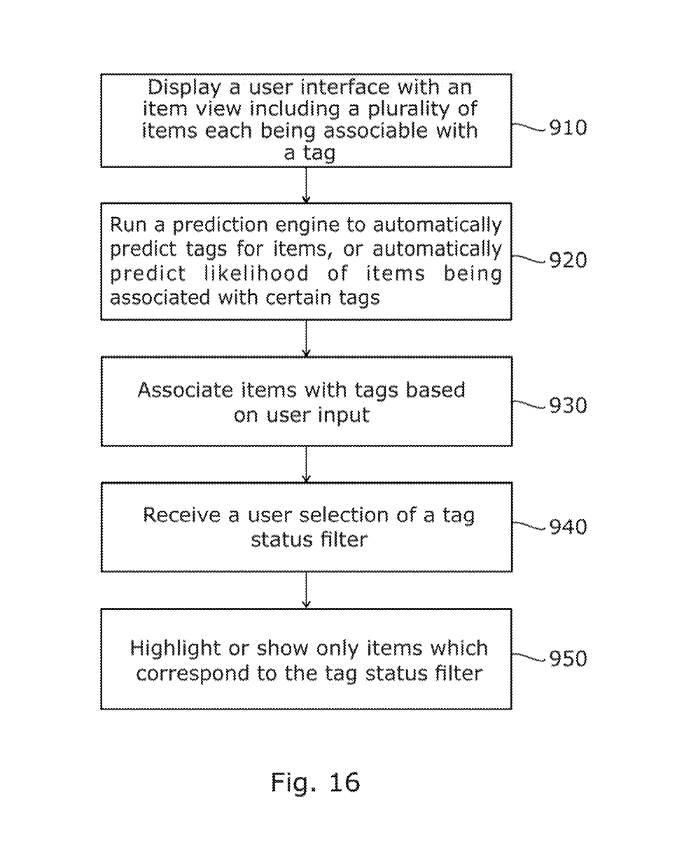

FIG. 16 is a flow diagram illustrating an example computer implemented method which uses a prediction engine and a tag status filter. The method may be implemented by a processor executing machine readable instructions stored on a non-transitory computer readable medium, such as memory, hard disk or the like.

At block 910 the computer system displays a user interface with an item view including a plurality of items each being associable with a tag.

At block 920 the computer system runs a prediction engine to automatically predict tags for items, or automatically predict likelihood of items being associated with certain tags.

At block 930 the computer system associates items with tags based on user input.

At block 940 the computer system receives a user selection of a tag status filter.

At block 950 the computer system highlights or shows only items which correspond to the tag status filter.

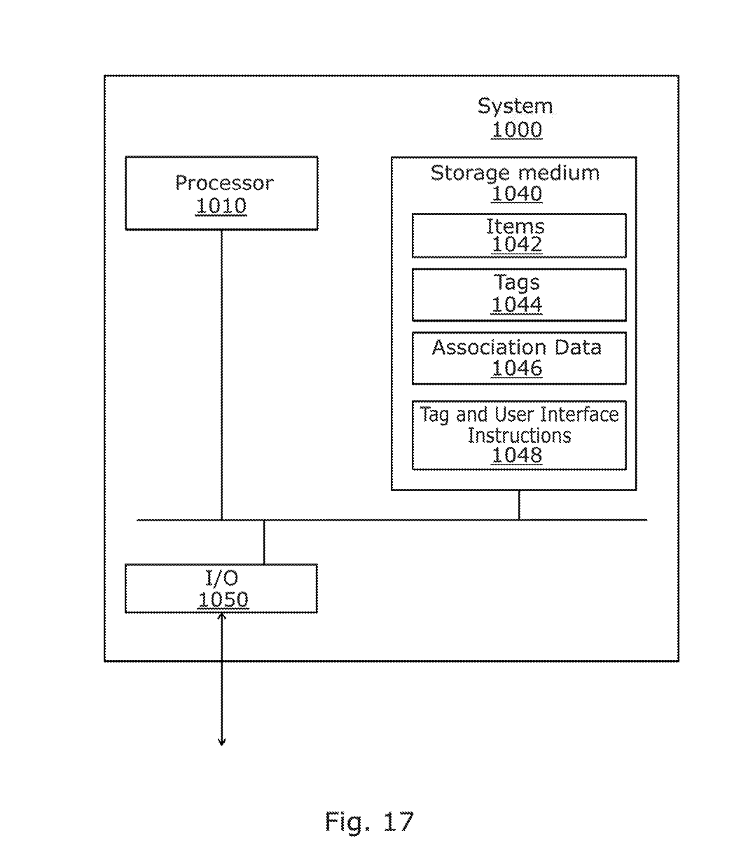

FIG. 17 shows an example system 1000 for implementing the various methods described herein. The system comprises a processor 1010, a storage medium 1040 and an in/out (I/O) interface 1050. The I/O interface may connect to a display for displaying the user interface and/or an input device or devices such as a keyboard, mouse, touchscreen, trackball, touchpad, camera or other types of optical detectors etc. The storage medium 1040 may be a memory, hard disk or other non-transitory computer readable storage medium. The storage medium stores data relating to the items 1042, tags 1044 and associations 1046 between the items and the tags. The storage medium may also store tag and user interface instructions 1048 which are machine readable instructions which are executable by the processor for implanting any one, any combination or all of the computer implemented methods described herein.

All of the features disclosed in this specification (including any accompanying claims, abstract and drawings), and/or all of the blocks of any method or process so disclosed, may be combined in any combination, except combinations where at least some of such features and/or blocks are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A computer implemented method comprising:
displaying a user interface including an item view including a plurality of items;
detecting a user selection of a tag;
in response to detecting the user selection of the tag, setting the selected tag as a tag in focus;
displaying a cursor having an appearance indicating the tag in focus at least when the user engages with a part of the item view relevant to tagging; and
in response to detecting a user selecting an item in the item view, associating the selected item with the tag in focus and storing the association between the item and the tag in focus in memory.

2. The computer implemented method of claim 1 comprising displaying a tag view including a plurality of tags in the user interface and determining that a tag is selected when the user selects the tag in the tag view.

3. The computer implemented method of claim 1 wherein setting the selected tag as the tag in focus activates a tagging functionality of the user interface in which the user can tag items in the item view and wherein the method further comprises allowing the user to perform, via the user interface, operations other than tagging without de-activating the tagging functionality.

4. The computer implemented method of claim 1 comprising displaying a cursor with which the user can interact with the user interface and modifying the appearance of the cursor to indicate the tag in focus in response to the user selecting a tag as the tag in focus.

5. The method of claim 1 comprising displaying, for each item in the item view, the tag or tags which the item is associated with.

6. The method of claim 1 comprising displaying the user interface on a touch screen and displaying a cursor in response to a user finger or stylus being in a predetermined proximity to the screen, or in response to a touch having a pressure or duration above a predetermined threshold.

7. The method of claim 1 further comprising removing an association between an item and a tag in response to the user selecting the item while the tag is the tag in focus.

8. A computer readable medium storing instructions that are executable by a processor to:
display a user interface including a tag view including a plurality of tags and an item view including a plurality of items;
set a tag as a tag in focus in response to detecting a user selecting said tag from among the plurality of tags in the tag view;
and subsequent to setting the tag as the tag in focus:
associate an item of interest of the plurality of items in the item view with the tag in focus responsive to the user selecting the item of interest in a first manner; and
associate the item of interest with a tag other than the tag in focus, or associate the item of interest with an additional tag, responsive to the user selecting the item of interest in a second manner.

9. The computer readable medium of claim 8 wherein:
a user selecting the item of interest in the first manner and the user selecting the item of interest in the second manner are manners which are different from each other and belong to the group comprising: the user clicking the item of interest in the item view, an extended user click on the item of interest lasting more than predetermined period of time, a double click on the item of interest, or a user click on a special user interface element associated with the item of interest.

10. The computer readable medium of claim 8 wherein the instructions enable a user to associate the item of interest with a tag other than the tag in focus, without changing the tag in focus and without selecting another tag from the tag view.

11. The computer readable medium of claim 8 wherein the instructions comprise instructions to:
in response to detecting a user selecting the item of interest in the second manner, display a menu or dialog box to allow the user to select or input a tag other than the tag in focus and, in response to the user input or selection of the tag other than the tag in focus, associate the tag other than the tag in focus, with the item of interest.

12. The computer readable medium of claim 8 wherein the instructions include instructions to:
when an item of interest in the item view is already associated with a tag other than the tag in focus, associate the item of interest with both the tag in focus and the tag other than the tag in focus, in response to the user selecting the item of interest in the second manner.

13. The method of claim 12, wherein the instructions include instructions to:
when an item of interest in the item view is already associated with a tag other than the tag in focus, remove the association with the tag other than the tag in focus, and associate the item of interest with the tag in focus, in response to the user selecting the item of interest in the first manner.

14. A computer readable medium storing instructions that are executable by a processor to:
display a user interface including an item view including a plurality of items;
detect a user selection of a tag;
in response to detecting the user selection of the tag, set the selected tag as a tag in focus and provide the user interface with tagging functionality; associate an item in the item view with the tag in focus in response to a user selection of the item in the item view;
allow the user to perform, via the user interface, operations other than tagging without the user first de-activating the tagging functionality or de-selecting the tag in focus;
and in response to the user returning to the item view and selecting another item, without the user first re-selecting the tag in focus or re-activating the tagging functionality, associate the another item with the tag in focus.

15. The computer readable medium of claim 14 wherein the instructions include instructions to display a tag view including a plurality of tags, set a tag as the tag in focus in response to detecting a user clicking the tag in the tag view and enable a user to associate an item in the item view with another tag different from the tag in focus, without selecting the another tag in the tag view, by engaging with the item in the item view in a special manner.

16. The computer readable medium of claim 14 wherein the instructions include instructions to display a cursor having a special appearance indicative of the tag in focus, when the user engages with the tag view or the item view.

17. The computer readable medium of claim 14 wherein the instructions includes instructions to, in response to detecting a user select a plurality of items one after the other in the item view, associate each item of the plurality of selected items with the tag in focus.

18. The computer readable medium of claim 14 wherein the instructions include instructions to detect a user selecting an additional tag button associated with an item which is already associated with a first tag and in response to said detection associate the item with both the first tag and a second tag.

19. The computer readable medium of claim 18 wherein the second tag is either the tag in focus, or a tag input by the user in the item view after selecting the additional tag button.

20. The computer readable medium of claim 14 further including instructions to run a prediction engine to automatically predict tags for the items, or automatically predict likelihood of items being associated with certain tags;
associate items with tags based on user input;
and in response to receiving a user selection of a tag status filter, highlight or show only items which correspond to the tag status filter; wherein the tag status filter is selected from the group comprising: a user input tag that contradicts the prediction engine, or items for which the likelihood predicted by the prediction engine is within a predefined range.
